(19) United States
(12) Patent Application Publication
(10) Pub. No.: US 2006/0054818 A1
(43) Pub. Date: Mar. 16, 2006

(54) Scanning apparatus and scanning methods for inspecting a surface of a semiconductor wafer

(76) Inventor: Jai-Dong Kim, Icheon-city (KR)

Correspondence Address: HANLEY, FLIGHT & ZIMMERMAN, LLC, 20 N. WACKER DRIVE, SUITE 4220, CHICAGO, IL, 60606, US

(21) Appl. No.: 11/214,319

(22) Filed: Aug. 29, 2005

(30) Foreign Application Priority Data
Sep. 14, 2004 (KR) 10-2004-0073487

(51) Int. Cl. G21K 7/00; G01N 23/00

(52) U.S. Cl. 250/310

(57) ABSTRACT

Scanning apparatus and scanning methods are disclosed for inspecting a surface of a semiconductor wafer. A disclosed example scanning apparatus includes a wafer stage to hold a wafer, a plurality of beam irradiators to respectively irradiate beams toward a plurality of inspection points on the surface of the wafer, a plurality of beam detectors respectively combined with the plurality of beam irradiators to form a plurality of irradiator-detector sets to detect reflected beams that are reflected from the inspection points on the surface of the wafer, a feeder unit to cause relative movement between the wafer stage and the plurality of irradiator-detector sets such that the entire surface of the wafer may be traversed by the inspection points, and a synthesizer to generate an inspection signal for the surface of the wafer by combining signals output from the plurality of beam detectors, wherein the relative movement of the wafer stage and a first one irradiator-detector sets is separate from that of the wafer stage and a second one of the irradiator-detector sets.

### FIELD OF THE DISCLOSURE

The present disclosure relates generally to semiconductor fabrication and, more particularly, to scanning apparatus and scanning methods for inspecting a surface of a semiconductor wafer for dust particles or defects from a surface image of the wafer obtained by detecting a reflective beam of a beam scanned on the surface of the wafer.

### BACKGROUND

Hereinafter, a conventional scanning apparatus and a conventional scanning method will be described with reference to FIG. 1 and FIG. 2.

FIG. 1 is a schematic diagram of a conventional scanning apparatus. As shown in FIG. 1, the conventional scanning apparatus includes a wafer stage 20 holding a semiconductor wafer 10, a beam irradiator 32 irradiating a laser beam toward a certain point (hereinafter, inspection point P) on the wafer, a beam detector 34 detecting a beam reflected from the surface of the wafer 10, and a feeding unit 40 feeding the wafer stage 20 along an x-axis and a y-axis. The illustrated feeding unit 40 includes an x-directional feeder 42 moving the wafer stage 20 along the x-axis direction, a y-directional feeder 47 moving the wafer stage 20 along the y-axis direction, and a controller 45 controlling the x-directional feeder 42 and the y-directional feeder 47.

The illustrated beam irradiator 32 includes a semiconductor diode emitting a single wavelength beam and a lens system collimating the emitted beam toward the inspection point P.

The beam detector 34 employs a photosensitive device, for example, a CCD (charge coupled device) to produce an electrical signal corresponding to the magnitude of the beam reflected from the wafer 10.

A beam emitted from the beam irradiator 32 is incident on the surface of the wafer 10 at a predetermined incident angle. The beam detector 34 is provided at a position where it can receive the beam reflected from the wafer 10 at a reflection angle corresponding to the incident angle. The beam detector 34 and the beam irradiator 32 are typically fixedly combined to form one irradiator-detector set 30 which is included in the scanning apparatus.

The feeder unit 40 moves the wafer stage 20 holding the wafer 10 along the x-axis direction and y-axis direction, such that the entire surface of the wafer 10 can be scanned, if desired.

Although not shown in FIG. 1, an apparatus that produces a surface image of the wafer based on the output signal of the beam detector 34 is additionally provided.

FIG. 2 illustrates a path of a scanning spot according to the conventional scanning apparatus. As shown in FIG. 2, the conventional inspection point follows a zigzag moving path from a first end of the wafer 10 to the other end thereof. The inspection point P is moved by the relative motion of the wafer stage 20. The actual direction of the irradiated beam does not move.

As can be appreciated from the above-description of the conventional scanning apparatus and method, only one inspection point moves relatively over the entire surface of the wafer from one end to the other end. Therefore, a substantial amount of inspecting time is required to inspect the entire surface. The long inspecting time may problematically limit an increase of productivity.

### BRIEF DESCRIPTION OF THE DRAWINGS

FIG. 1 is a block diagram of a conventional scanning apparatus for inspecting a surface of a wafer.

FIG. 2 shows a path of a scanning spot for the conventional scanning apparatus of FIG. 1.

FIG. 3 is a block diagram of an example scanning apparatus constructed in accordance with the teachings of the present invention.

FIG. 4 illustrates an example path of a scanning spot.

FIG. 5 is a block diagram of another example scanning apparatus constructed in accordance with the teachings of the present invention.

FIG. 6 shows another example path of a scanning spot.

### DETAILED DESCRIPTION

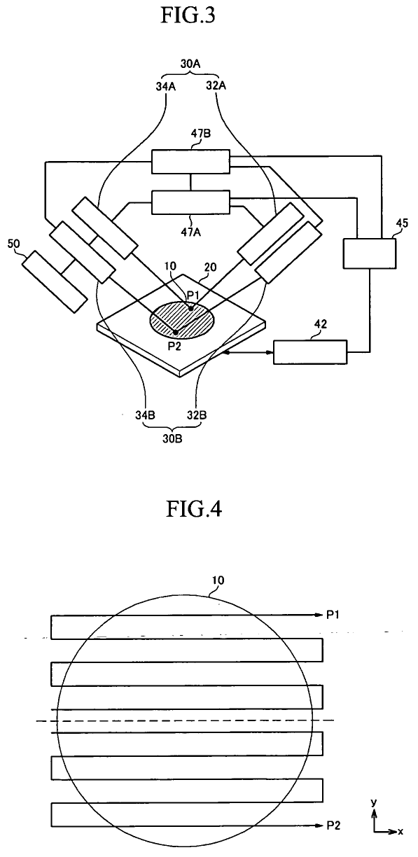

FIG. 3 is a schematic illustration of the structure of an example scanning apparatus constructed in accordance with the teachings of the present invention.

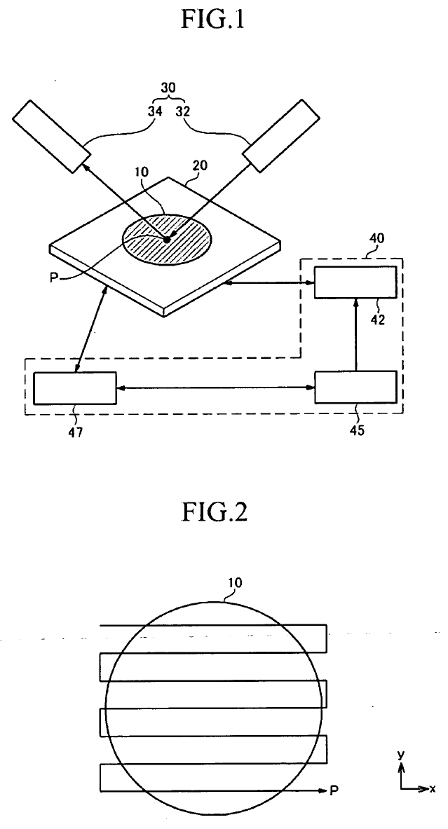

The example apparatus of FIG. 3 has some components in common with the conventional apparatus described above in connection with FIG. 1. For example, the apparatus of FIG. 3 operates on a semiconductor wafer 10, and includes a wafer stage 20, beam irradiators 32A and 32B, and beam detectors 34A and 34B which are the same or substantially the same as the corresponding components of the above described convention apparatus. In the interest of brevity, a detail description of these components will not be repeated here. Instead, the interested reader is referred to the above description for a more detailed discussion of these components. To this end, like components in FIG. 3 and FIG. 1, are labeled with the same reference numerals.

Unlike the conventional apparatus described above, the example apparatus of FIG. 3 includes two irradiator-detector sets 30A and 30B. One irradiator-detector set 30A includes a beam irradiator 32A and a beam detector 34A. The other irradiator-detector set 30B includes a beam irradiator 32B and a beam detector 34B. As described above, the beam irradiator and the beam detector included in each set are fixedly combined with each other, such that they move integrally together. Such a fixed combination of a beam irradiator and a beam detector enables stable and accurate detection of the reflected beam of the irradiated beam and is, thus, preferred, although other implementations including, for example, implementations in which a beam irradiator and a paired beam detector are independently movable relative to one another.

However, unlike the prior art, each of the two beam irradiator-detector sets 30A and 30B of the example of FIG. 3 is independently movable with respect to the other one of the beam irradiator-detector sets 30A, 30B. In the example of FIG. 3, each of the two irradiator-detector sets 30A and 30B is independently moved along the y-axis direction by a corresponding y-directional feeders 47A and 47B, respectively. On the other hand, the wafer stage 20 is moved along the x-axis direction by an x-directional feeder 42. The x-directional feeder 42 and the y-directional feeders 47A and 47B are controlled by a controller 45.

A synthesis component 50 receives output signals from the beam detector 34A and the beam detector 34B, and synthesizes an image of the complete surface of the wafer based on those signals.

An example scanning method performed using the scanning apparatus of FIG. 3 will now be described with reference to FIG. 3 and FIG. 4.

While the semiconductor wafer 10 is held on the wafer stage 20, the beam irradiators 32A and 32B respectively irradiate beams. As a result, two scanning spots are formed on the surface of the wafer 10. Consequently, the scanning of the surface of the wafer 10 may be enabled through two inspection points P1 and P2 on the surface of the wafer 10. The beam irradiated from the beam irradiator 32A is detected by the beam detector 34A, and the beam irradiated from the beam irradiator 32B is detected by the beam detector 34B.

Next, the beam irradiator-detector sets 30A and 30B are respectively moved, such that each beam spot is located at the starting point of the detecting operation. Then, the x-directional feeder 42 is operated to move the wafer stage 20, so that the inspection points P1 and P2 move relatively on the surface of the wafer along the x-axis. As this occurs, each of the beam detectors 34A, 34B detect a beam reflected from the surface of the wafer, convert it to an electrical signal, and send the signal to the synthesis component 50.

After the inspection points P1 and P2 have been moved fully across the wafer, each of the beam irradiator-detector sets 30A and 30B is moved along the y-axis by a small, substantially equal feeding amount in opposite directions. The irradiator-detector sets 30A and 30B are respectively moved by the y-directional feeders 47A and 47B.

In this manner, the scanning spots P1 and P2 move over the entire surface of the wafer 10 along the path shown in FIG. 4, while moving the wafer stage 20 and the irradiator-detector sets 30A and 30B in their corresponding directions.

In the example shown in FIG. 4, the time required for scanning the entire surface of the wafer is reduced by half, compared to the conventional method using only one beam irradiator-detector set.

FIG. 5 is a planar block diagram of another example scanning apparatus constructed in accordance with the teachings of the present invention. In the example shown in FIG. 5, the beam irradiator-detector sets 30A and 30B are structured to be moved by feeding units 40A and 40B, and the wafer stage 20 is fixed. All of the other features are the same as in the above-described example shown in FIG. 3.

In the example of FIG. 5, the feeders 40A and 40B may respectively move the irradiator-detector sets 30A and 30B along both the x-axis direction and y-axis direction. Therefore, a wafer may be fully scanned, even though the wafer stage 20 is fixed.

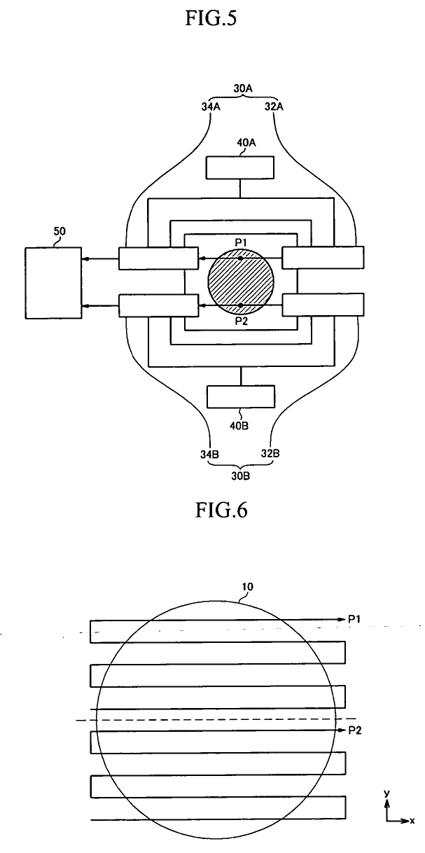

FIG. 6 shows another example scanning path for scanning the surface of a wafer. In the example of FIG. 4, two inspection points P1 and P2 move symmetrically in opposite directions with respect to a center of a central line of the wafer. However, in the example of FIG. 6, the inspection points are moved in the same pattern, i.e., in parallel with each other.

When the inspection points are moved in the pattern shown in FIG. 6, the two irradiator-detector sets 30A and 30B are not required to separately move in order to scan the entire surface of the wafer. That is, the entire surface of the wafer may be scanned simply by integrally moving the irradiator-detector sets 30A and 30B while maintaining a constant distance therebetween. Consequently, the irradiator-detector sets 30A and 30B can be moved by one feeder unit. Therefore, it is not required for each irradiator-detector set to be provided with a respective feeder unit, and, thus, the manufacturing cost can be reduced.

In the above-described examples, two irradiator-detector sets are employed. However, the present disclosure is not limited to any particular number of irradiator-detector sets. To the contrary, two or more irradiator-detector sets may be used. However, if more than two irradiator-detector sets are used, manufacturing cost may be increased.

In the above-described examples, only two example scanning paths are illustrated. However, persons of ordinary skill in the art will appreciate that the scanning can be performed in a wide variety of other patterns without departing from the scope or spirit of this disclosure.

By employing the example scanning apparatus and/or method described above, the time required for scanning an entire surface of a wafer may be reduced by half or more, in comparison with the conventional scanning time required when using the conventional apparatus in which only one irradiator-detector set is employed. Such a reduction of scanning time results in an increase of productivity and yield.

From the foregoing, persons of ordinary skill in the art will appreciate that, by using at least two beam irradiator-detector sets, the time required for scanning a surface of a wafer is reduced by half or more, in comparison to a conventional scanning method using a conventional scanning apparatus.

A disclosed example scanning apparatus for inspecting the surface of a semiconductor wafer includes a wafer stage holding a wafer, a plurality of beam irradiators respectively irradiating beams at a predetermined angle relative to a plurality of inspection points on the surface of the wafer, a plurality of beam detectors respectively combined with the plurality of beam irradiators to form a plurality of irradiator-detector sets and detecting reflected beams that are respectively irradiated from the plurality of beam irradiators and reflected at the inspection points on the surface of the wafer, a feeder unit causing a relative movement between the wafer stage and the plurality of irradiator-detector sets such that the entire surface of the wafer may be scanned by the relative movement, and a synthesis module generating an inspection signal for the entire surface of the wafer by combining signals output from the plurality of beam detectors, wherein the relative movement of the wafer stage and one irradiator-detector set is separate from that of the wafer stage and another irradiator-detector set.

In some examples, the plurality of irradiator-detector sets comprise first and second irradiator-detector sets, and the feeder unit moves the first and second irradiator-detector sets such that the first and second irradiator-detector sets scan respective regions on the surface of the wafer divided by a central line thereof. The synthesis component generates an inspection signal for the entire surface of the wafer by combining signals output from respective irradiator-detector sets.

In some examples, the feeding unit moves the wafer stage vertically in a first direction and the plurality of beam irradiator-detector sets in a second direction crossing the first direction, such that the inspection points travel on the surface of the wafer in a zigzag pattern.

A disclosed example scanning method for detecting dust particles and defects on the surface of a wafer includes irradiating beams toward the surface of the wafer at a predetermined angle relative to two beam irradiators, moving the two beam irradiators and a wafer stage holding the wafer relative to one another such that the two beams irradiated from the beam irradiators simultaneously scan different regions of the wafer, generating an inspection signal of the surface of the wafer by combining signals output by the beam detectors detecting the respective beams, and determining whether dust particles or defects exist on the wafer based on the inspection signal.

It is noted that this patent claims priority from Korean Patent Application Serial Number 10-2004-0073487, which was filed on Sep. 14, 2004, and is hereby incorporated by reference in its entirety.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A scanning apparatus to inspect a surface of a semiconductor wafer for dust particles or defects, comprising:
a wafer stage to hold a wafer;
a plurality of beam irradiators to respectively generate irradiating beams directed toward a plurality of inspection points on the surface of the wafer;
a plurality of beam detectors combined with respective ones of the plurality of beam irradiators to form a plurality of irradiator-detector sets, each of the beam detectors being positioned to detect a reflected beam originating at a respective one of the plurality of beam irradiators and reflected from a respective one of the inspection points;
a feeder unit to cause a relative movement between the wafer stage and the plurality of irradiator-detector sets such that substantially the entire surface of the wafer may be inspected; and
a synthesizer to generate an inspection signal for the surface of the wafer by combining signals output by the plurality of beam detectors,
wherein the relative movement of the wafer stage and a first one of the irradiator-detector sets is separate from the relative movement of the wafer stage and a second one of the irradiator-detector sets.

2. A scanning apparatus as defined in claim 1, wherein:
the feeder unit moves the irradiator-detector sets such that the first and second ones of the irradiator-detector sets scan respective regions on the surface of the wafer, the regions being located on opposite sides of a center of the wafer; and
the synthesizer generates an inspection signal for the entire surface of the wafer.

3. A scanning apparatus as defined in claim 2, wherein the feeder unit moves the wafer stage in a first direction and the feeder unit moves the plurality of beam irradiator-detector sets in a second direction substantially perpendicular to the first direction, such that the inspection points traverse the surface of the wafer in a zigzag pattern.

4. A scanning method for detecting dust particles and defects on the surface of a wafer, comprising:
irradiating beams toward the surface of the wafer at a predetermined angle with at least two beam irradiators;
moving the at least two beam irradiators and a wafer stage holding the wafer relative to one another such that the two beams simultaneously scan different regions of the wafer;
generating an inspection signal by combining signals output from the beam detectors detecting the respective beams; and
determining whether dust particles or defects exist on the wafer based on the inspection signal.
